(19) United States
(12) Patent Application Publication
(10) Pub. No.: US 2003/0104107 A1
(43) Pub. Date: Jun. 5, 2003

(54) Energy drink formula and method

(76) Inventor: William Gillota, Tequesta, FL (US)

Correspondence Address: REED SMITH CROSBY HEAFEY LLP, 1901 AVENUE OF THE STARS, SUITE 700, LOS ANGELES, CA, 90067, US

(21) Appl. No.: 10/278,679

(22) Filed: Oct. 23, 2002

Related U.S. Application Data
(60) Provisional application No. 60/339,589, filed on Oct. 26, 2001.

(51) Int. Cl. C12C 1/00

(52) U.S. Cl. 426/590

(57) ABSTRACT

The present invention is an energy drink formula and method, which safely provides individuals with, enhanced athletic stamina and energy. The present invention is made from natural ingredients, including vitamins and minerals. The present invention may be in the form of a powder, which is later added to water, or can be made directly as a liquid drink.

The present application is based on and claims priority from U.S. Application No. 60/339,589, filed Oct. 26, 2001, which is specifically incorporated herein by reference.

### BACKGROUND OF THE INVENTION

1. Area of the Art

The present invention is a nutritional drink formula and method. More particularly, the present invention is a sports drink designed to improve personal athletic performance and increase athletic stamina and energy.

2. Description of the Prior Art

In recent times, more and more people are partaking in athletic activities of all types and at all levels. This trend is true of all facets of the population including children, adults, blue collar workers, professionals, men, women, and so on.

Given that the United States is one of the hardest working countries in the world, stamina required for athletic activity can sometimes wane. And while many attempt selective diets, vitamins, and stimulants (such as coffee or tea), to increase their athletic prowess, there is no one remedy to assure lasting and continued stamina in addition to quick and full recovery after athletic activity. This is particularly true given today's focus on natural, holistic products.

A number of inventions exist which attempt to address the need for increased stamina. For example, the reference to Langer et al., U.S. Pat. No. 4,737,367 discloses an improved, tasty fruit-flavored beverage, which contains all, or substantially all, of the U.S. Recommended Daily Allowance of vitamins. This drink is a combination of orange, pineapple, apple, grape, pear, apricot, peach, nectarine, and banana puree designed to replenish lost vitamins; however, this reference does not provide energy or stamina for athletic activity, nor direct recovery benefits for post-exercise activities.

The reference to Schechter, U.S. Pat. No. 6,071,547 discloses a dry mix formulation for a nutritional drink that contains, among other ingredients, an optional vitamin-mineral mixture. Once again, while this invention is designed to replenish lost nutrients, it does not provide increased stamina or enhanced athletic recovery rates.

The reference to Fratzer, U.S. Pat. No. 4,874,603 discloses the use of Vitamin E for normalization of blood coagulation. While this reference provides medical benefits to patients having blood coagulation problems, it is not designed to increase stamina and recovery associated with athletic activity.

Similarly, the reference to Baumann, U.S. Pat. No. 6,103,755, utilizes vitamins in a foodstuff to ameliorate cardiovascular diseases and cancer. Once again, while this invention confers certain medical benefits, it is not intended for enhanced athletic stamina and energy.

Finally, the reference to Atkinson, et al. U.S. Pat. No. 6,207,203, discloses a fortified coffee drink providing protein, vitamins and minerals, in addition to caffeine. While this invention is alleged to increase user awareness, enhanced athletic performance is not contemplated. Indeed, the use of caffeine during athletic activity may inhibit, rather than enhance, athletic stamina and could negatively affect health.

The prior art is attempting to solve the problem of beverages designed for physical activity with a “one size fits all” approach. The present inventor has determined that there are really two aspects to the problem. The athlete requires a beverage to replenish water, salts and energy during physical activity to sustain energy and help prevent soreness and other training injuries. Such an “energy drink” should also contain vitamins and other biological factors to aid in absorption, etc. However, such a beverage cannot have either the nutrient or biological factor levels necessary to ensure optimal recovery and stamina for later exercise because the required levels would impede absorption during exercise and would negatively affect the blood sugar. Therefore, it is necessary to provide one beverage for use during exercise and a second “recovery” beverage for use between exercise episodes. In view of the foregoing, there is a need for an invention that overcomes the deficiencies of the prior art by providing an improved energy drink for sustaining energy levels and enhancing stamina during vigorous exercise or similar athletic activity.

### SUMMARY OF THE INVENTION

The present invention provides a unique formula for energy and hydration during strenuous activity. A sixteen-ounce serving provides energy, hydration, minerals and nutrients. The formula provides arbohydrate energy from glucose (dextrose) (approximately 3-10 calories per ounce). A combination of straight chain amino acids (glutamine and glycine) and branched chain amino acids (valine, isoleucine and leucine) with a molar ratio of glycine to glutamine to valine to isoleucine to leucine of approximately 5:2:2:2:3 (molar ratio of approximately 1:1 straight chain to branched chain amino acids), are provided to supplement glucose for energy production in muscle tissue. The weight ratio of glucose to total amino acids is between about 100:1 and 200:1. Between 25 mg and 100 mg of calcium (from calcium carbonate) is provided per serving. It is believed that the hypotonic combination of salts (calcium, magnesium, zinc, sodium and potassium at an approximate weight ration of 10:1.5:1:36:14) and glucose provides for rapid and painless absorption of water, salts and carbohydrate. Approximately 10%-300% percent of the recommended daily requirement of Vitamin B₁₂ and pantothenic acid are provided per serving along with between 10% and 300% of the recommended daily value of vitamin C and vitamin E. Between 1% and 150% of vitamin A (as retinyl acetate) is also provided. The vitamins facilitate metabolism and provide significant antioxidants (both water and lipid soluble). The antioxidant effect is backed up by rutin, an antioxidant bioflavanoid glycoside provided at a weight between about 0.5 and 1.5 times the weight of vitamin C of between. Glucosamine is provided for the long-term condition of connective tissue and joint lubricity. Glucosamine is provided at a molar ratio glucose:glucosamine of between about 300:1 and about 800:1. The preferred embodiment produces and optically clear, stable solution. It will be appreciated by those of skill in the art the precise quantities of the ingredients can be varied somewhat so long as a hypotonic, clear solution is obtained.

### DESCRIPTION OF THE FIGURES

FIG. 1 is a table listing the ingredients in an embodiment of the inventive composition. Serving size is sixteen ounces and daily value (DV) is based on a 2000-calorie diet.

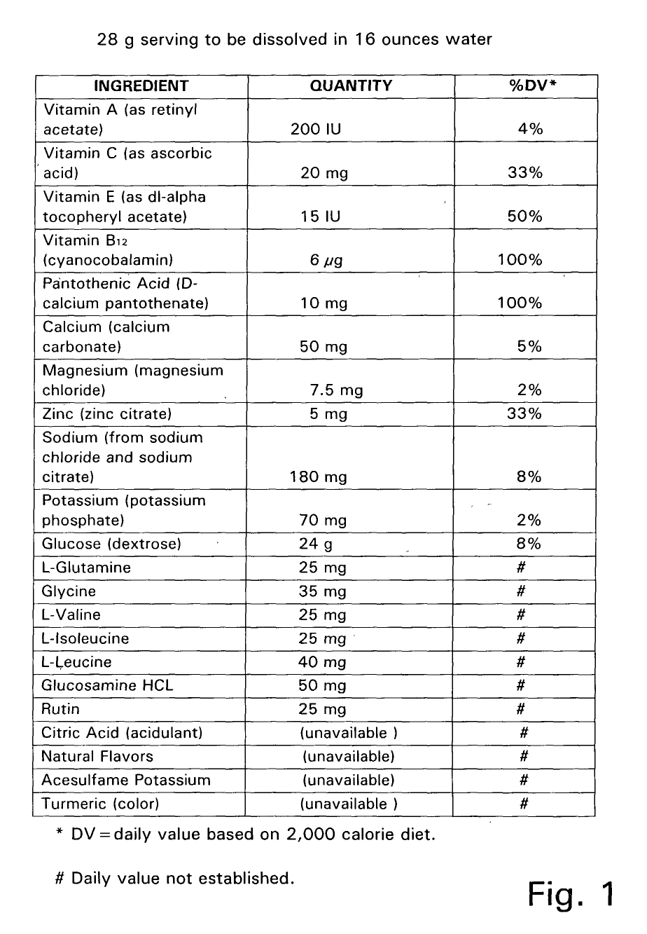

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved energy drink for athletic activities.

Embodiments consistent with the present invention address the need for an efficient energy formula and method that provides a safe and reliable energy source for athletes, professionals, laborers and the general public. While the prior art attempts to address this need, only the present invention is able to accomplish this goal. The present invention is described with regard to a drink formula.

Glossary

These terms have the following meanings herein:

Acidulant—An acid compound (such as citric acid) used to modify the flavor and or aid in the preservation of a food product by lowering the pH.

Aerobic—With oxygen.

Aerobic activity—A low-intensity, high endurance activity that requires oxygen for endurance.

Amino Acid—The linking together molecules of protein (linked though peptide bonds) that forms the building blocks for the cells of the body.

Anabolic—The biochemical process in which different molecule combine to form larger, more complex molecules.

Anabolism—The biochemical process in which different molecule combine to form larger, more complex molecules.

Anaerobic—Without oxygen.

Anaerobic activity—A high intensity, low endurance activity that requires bursts of energy for power and speed.

Anion—A negatively charged ion (e.g., chloride).

Anticatabolic—Describing a substance that prevents the catabolic process (the break down of complex molecules) from occurring.

Antioxidant—A nutrient that has been found to seek out and neutralize free radicals in the body, generally prevent inappropriate oxidation of cellular components and thereby help the body to recover more quickly from the damage caused by free radicals and oxidative stress.

BCAA—Branched chain amino acids L-Lsoleucine, L-Leucine, and L-Valine. These make up about 35 percent of the total amino acids in muscle tissue.

Bioavailability—The ability of an ingested nutrient to cross from the digestive tract into the bloodstream and then from the bloodstream into the cells in which it will be utilized.

Bioflavonoids—A group of naturally occurring antioxidant plant compounds that help maintain and strengthen the artery walls of the circulatory system.

Carotenoids—A class of chemical that displays Vitamin A activity. They are made by plants and are converted to Vitamin A within the body.

Catabolism—The biochemical process in which complex molecules are broken down for energy production, recycling of their components, or excretion.

Cation—A positively charged ion.

Coenzyme—An enzyme cofactor or substance needed for an enzyme to perform its function.

Cofactor—A substance that must be present for an enzyme to be able to perform a specific function.

Collagen—A structural protein that is the chief component of connective tissue.

Complex carbohydrates—A polysaccharide (carbohydrate that has 3 or more sugar molecules bound together) such as starch, dextrin, cellulose, and glycogen (which are all glucose polymers).

Cortisol—A hormone secreted by the adrenal glands that stimulates the breakdown of complex molecules for energy.

DNA—Deoxyribonucleic acid. The substance in the cell's nucleus that contains the cell's genetic blueprint and determines the sequence of all the proteins made by the cell.

Epithelial cells—The type of cells that compose such structures as the linings of the lungs and digestive system.

Ergogenic—A catchall term that describes anything that can be used to enhance athletic performance. Ergogenic aids can be dietary or non dietary and include dietary supplements, special training techniques, and mental strategies.

Free radical—One of the highly reactive molecules that are known to injure cell membranes and other cellular components, cause damage to DNA and contribute to the aging process and a number of other degenerative diseases and illnesses. Free radicals are unintended byproducts of normal chemical reactions in the body that involve oxygen.

GABA—Gamma-aminobutyric acid an amino acid and neurotransmitter that is calming to the brain. This calming effect can be beneficial to athletes who require concentration or steadiness. It can also assist athletes who are effected by stress.

GH—Growth hormone.

Hemoglobin—The red protein that carries oxygen in red blood cells.

Krebs Cycle—The metabolic process by which energy is released from glucose, fatty acid or protein molecules and used to regenerate adenosine triphosphate (ATP) molecules (also known as the tricarboxylic acid cycle).

Lactic acid—A toxic byproduct of anaerobic glucose metabolism.

Neurotransmitter—A chemical substance that aids in the transmission of nerve impulses.

Nitrosamines—Organic compounds present in various foods and found to produce cancer in laboratory animals.

Osmotically balanced—A combination of ions that enhances the body's cellular ability to efficiently and effectively absorb the ingredients and nutrients.

Oxidation—A chemical reaction in which an atom or molecule loses electrons.

pH—Potential of hydrogen. The negative logarithm of the concentration of hydrogen ions in a solution-numbers below 7 indicate an acid condition.

Phenols—Often toxic organic chemicals detoxified in the liver and bound in the form of bile salts.

Phenylalanine—Is an essential amino acid and is the precursor of several important metabolites such as the skin pigment melanin.

Phospholipids—A macronutrient. Phospholipids are the second major class of lipids. They are a major structural part of every living cell where they make up the cell membranes.

Potentiator—A substance that helps another substance perform its function.

Prostanoid—A derivative of the hormone prostaglandin, which is important in metabolism and in the reproductive process, and blood-platelet aggregation.

Reversed engineered—Starting with desired performance criteria, then selecting ingredients and quantities that create the desired results/effects based upon scientific research.

RNA—Ribonucleic acid. The substance that carries the coded genetic information from the DNA, in the cell nucleus, to the ribosome's, where the instructions are translated into the form of protein molecules.

Synthesize—To form or make up.

Tyrosine—An amino acid. The precursor of nonrepinephrine and dopamine, regulates appetite, and aids in melanin production.

Uptake—Absorption, as in absorption by the cells and into the cells.

The present invention is a unique energy drink specifically designed and engineered to improve athletic performance during physical activity.

The present invention provides a nutritionally balanced and supplemented energy drink for the training room and athletic field that will greatly improve personal performance. The present invention is designed to assist the body in achieving optimum performance levels. For overall support of athletic training it is believed that intake of adequate water, calories, amino acids, minerals and other nutrients are necessary. Supplement drinks are beneficial because a typical diet may not provide all of the required factors. However, a single supplement drink is not the overall answer because a drink providing sufficient nutrients and calories for overall training recovery is not compatible with the need for energy and hydration during strenuous exercise. Rather, the inventor has divided the overall requirements into an energy drink for use during physical activity and a recovery drink for use between exercise bouts. The present invention concerns the first of these two complementary beverages.

The present invention sustains physical exercise and contains special ingredients to provide, directly or indirectly, benefits that include:

Promoting the development of lean, strong efficient muscle mass.

Increasing total physical strength.

Extending physical endurance.

Improving flexibility.

Enhancing agility.

Increasing speed.

Improving circulation.

Increasing anaerobic capacity and endurance.

Raising individual performance levels and results.

Physical Properties

A non-effervescent powder to be mixed with water. This powder, coated granular mix, when mixed with water becomes a hypotonic solution. The powder is to be mixed with 16 ounces of water for individual dosage mix. It can also be premixed and sold in liquid form. The resulting mixture dissolves in tap water without clumping, floating or settling.

The present invention dissolves completely and forms a clear transparent solution. It leaves no residue on the top, sides or bottom of the mixing or delivery vessel. This result is achieved by mixing 28 g of the formula with about 3 ounces of hot tap water (120-150° F.) and mixing vigorously. After that 13 ounces of cold or ice water is added and mixed to yield the desired clear, stable solution. In one preferred embodiment, the present invention is subtly lemon flavored, not too sweet and slightly saline.

Ingredients

The inventive formula is a glucose-based formula. Carbohydrates such as glucose are ideal energy sources because they most effectively replenish glycogen stores in the muscles and liver. In addition, they sustain the blood sugar level sufficiently for long sessions of intensive training. If the athlete's energy stores become drastically depleted if they experience lactic-acid build up, they will suffer temporary muscle fatigue.

The present invention contains the following ingredients in balanced and meaningful quantities:

Vitamins A, C, E, B₅, and B₁₂

Vitamin A, a fat-soluble vitamin is essential for maintenance of vision and proper cellular growth and development. It is needed for the proper maintenance and integrity of the immune system; for the formation and maintenance of healthy skin, hair, and mucous membranes; as well as for bone growth and tooth development.

Vitamin C is primarily a water-soluble antioxidant that cannot be synthesized by the human body. It is involved in the formation and maintenance of collagen, a protein that is an important component of skin, ligaments, and bones. It helps heal wounds, may help fight infections, and promotes healthy capillaries, gums and teeth.

Vitamin E, another fat-soluble vitamin, assists in red blood cell formation, acts as an antioxidant, and aids in the regulation of prostanoid synthesis. Prostanoids are compounds that are important in the reproductive process, and blood-platelet aggregation (clustering). Of interest to athletes, Vitamin E has also been shown to lower the bloodlactate level, decrease the formation of certain waste products during exercise, reduce oxidative cellular damage, maintain muscle tissue, and possibly help testosterone production.

Vitamin B₅ (panthothenic acid) has many metabolic functions that are vital in the release of energy from carbohydrates and fatty acids. The vitamin is also involved in steroid and cholesterol synthesis.

Vitamin B₁₂ is regarded as the primary energy vitamin. Vitamin B₁₂ functions in the body in new cell growth nerve tissue development, folate metabolism, and DNA synthesis and energy production. It is necessary for the synthesis of red blood cells and, therefore, for the prevention of anemia.

Osmotically Balanced Electrolytes, Sodium, Potassium and Magnesium

Osmotically Balanced is defined herein as a product that enhances the body's cellular ability to absorb, efficiently and effectively, the ingredients and nutrients for optimum utilization. Osmotically balanced electrolytes facilitate uptake of water and nutrients while minimizing digestive distress.

Sodium is the body's main extra-cellular cation. Sodium helps regulate the body's volume of extra-cellular fluids, particularly the blood. It also helps regulate pressure of these fluids, aids the active transport of nutrients across cell membranes, and assists the uptake of some nutrients in the intestines. In addition, it functions in muscle contraction and nerve impulse transmission. Significant amounts of sodium are lost through perspiration and must be replenished.

Potassium functions in the body primarily as an intercellular cation. It helps maintain fluid balance and functions in nerve transmission muscle contraction and glycogen formation.

Magnesium plays many metabolic and structural roles. It helps form bone and teeth, functions in muscle tissue development and the proper function of the nervous system, as well as a cofactor for activating many enzymes. It assists in calcium and potassium uptake and glycolysis, as well as many other metabolic processes. It aids the muscle to relax preventing muscle spasms, tremors and convulsions. It is a critical element in the treatment of chronic fatigue, which involves muscle aches and pains.

Calcium and Zinc

In addition to calcium's role as the primary nutrient needed for bone formation and maintenance, calcium also plays essential roles in nerve conduction, nerve impulse transmission, heart rate, muscle contraction, cell-membrane permeability, and blood clotting. It also functions as an enzyme cofactor.

Zinc plays many important metabolic roles in the body. It is part of various metallo-enzymes (mineral-containing enzymes) that function in growth, testosterone production, DNA synthesis, cell replication and prostate gland functioning.

Amino Acids: Straight-Chain Amino Acids L-Glutamine and Glycine, and Essential Branched-Chain Amino Acids L-Leucine, L-Valine and L-Isoleucine

L-glutamine is essential for the proper functioning of the brain. It is an energy source in the brain and a mediator of glutamic acid and GABA activity. L-glutamine is also vital to immune system functioning and is required for cellular replication in the immune system. However, the majority of L-glutamine is made in the muscles.

Glycine is an important precursor of many substances, including protein, DNA, phospholipids, collagen, and creatine. It is also a precursor in the release of energy. It is necessary for the proper functioning of the central nervous system and is an inhibitory neurotransmitter.

L-leucine is an essential amino acid found in proteins, like the other branched-chain amino acids (BCAAs), important in energy production during exercise. According to estimates, up to 90 percent of dietary Lleucine may be used for energy in existing muscles. This makes L-leucine a very limiting amino acid if supplemental amounts are not taken to compensate for the loss. L-leucine has been shown to help spare muscle tissue, maintain nitrogen balance, and promote muscle growth and healing.

L-valine is involved in tissue repair, nitrogen balance, and muscle metabolism. It regulates how the body uses protein and plays a unique role in protein metabolism in muscles. Intense physical exercise produces a rapid excretion of nitrogen, which causes a decrease in muscle protein synthesis. L-valine limits this decrease.

L-Isoleucine, as the other BCAAs, is an integral part of muscle tissue and may be used for energy by exercising muscles. L-isoleucine is found in proteins and is needed for the formation of hemoglobin. It is involved in the regulation of blood sugar and is metabolized for energy in muscle tissue during exercise. Intense physical exercise produces a rapid excretion of nitrogen, which causes a decrease in muscle protein synthesis. L-isoleucine limits this decrease.

Other Probiotics: Amino Sugars and Flavonoids

Glucosamine, an amino sugar, has properties that benefit all types of connective tissue. Connective tissue contains two main components. The chief component is-collagen, which is the most common protein in the body, making up one-third of the body's total protein volume. The other component is proteoglycan, which forms the framework for collagenous tissue and also acts as a lubricant in joints. Glucosamine is one of the few known ingredients that aid in the synthesis of proteoglycan.

Rutin a water-soluble bioflavonoid and naturally occurring plant compound associated with Vitamin C. Bioflavonoids actually improve the Vitamin C absorption. They also have an anti-inflammatory effect. They exhibit antioxidant activity and help reduce the destruction of Vitamin C.

### Descriptive Relationships of the 22 Ingredients Used in the Formulation of the Present Invention

Note: “Active Ingredients” are those ingredients that have a daily requirement set by the Federal Drug Administration. The terminology is not intended to imply that “Inactive” ingredients lack functionality.

Active Ingredients:

Vitamin A (as retinyl acetate)

Quantity—200 IU (mg)

Value/range—4% daily value

Importance—Vitamin A plays many roles in the body. It is essential for maintenance of vision and proper cellular growth and development. It is necessary for reproduction, since it is involved in the proper function of the reproductive organs. Vitamin A is needed for the proper maintenance and integrity of the immune system; for the formation and maintenance of healthy skin, hair, and mucous membranes; as well as for bone growth and tooth development. It also has been implied that it has or performs some anticancer functions. This suggests that maintaining a proper intake of the carotenoids may help reduce the risk of lung cancer.

Performance Parameters—Scientists speculate that this anticancer activity is due partially to Vitamin A's role in promoting the development of normal epithelial cells. Epithelial cells compose such structures as the linings of the lungs and digestive system. In addition to all of Vitamin A's functions, it is an antioxidant, able to quench free radicals, particular singlet oxygen. This helps reduce cellular, molecular, and tissue damage by free radicals, whose numbers are greatly elevated by exercise and increased oxygen uptake.

Alternative Ingredient—None known. In this formulation this ingredient is critical because Vitamin A is not a water-soluble vitamin. This form of Vitamin A (ingredient) is more readily soluble in water, which is critical to the taste and clear appearance of the drink. Other forms of Vitamin A can leave an oily residue and or result in a cloudy solution. They can also discolor the skin. The form used in the present invention also remains in solution and will not settle when chilled or left in solution for long periods of time while maintaining its potency.

Limitations/Undesired Characteristics—None known for this dosage.

Vitamin C (as ascorbic acid)

Quantity—20 mg

Value/range—33% daily value

Importance—Vitamin C (ascorbic acid) is primarily a water-soluble antioxidant that cannot be synthesized by the human body. Neither is it stored in the body in any significant amount. Therefore, it is an essential vitamin. In addition, a slightly altered form of ascorbic acid, called dehydroascorbic acid, is present in the diet. This oxidized form also displays some Vitamin C activity. It has multiple functions as a cofactor and coenzyme. It is involved in the formation and maintenance of collagen, a protein that is an important component of skin, ligaments, and bones. It helps heal wounds, may help fight infections, and promotes healthy capillaries, gums and teeth. It prevents the oxidation of folate, aids in the intestinal absorption of iron, and assists in the metabolism of tyrosine and phenylalanine. It protects cells from free radical damage and blocks the production of nitrosamines, organic compounds present in various foods and found to produce cancer in laboratory animals.

Performance Parameters—Today, many people tout it as a general cure-all. For athletes, studies have indicated that Vitamin C plays a part in increasing muscular strength, reducing the blood-lactate level, and sparing glycogen.

Alternative Ingredient—None known. It is the most effective form of Vitamin C. In this formulation this ingredient is needed because of it is readily soluble in water, which is critical to the taste and clear appearance of the drink. It also remains in solution and will not settle when chilled or left in solution for long periods of time while maintaining its potency.

Limitations/Undesired Characteristics—None known for this dosage.

Vitamin E (as di-alpha tocopheryl acetate)

Quantity—15 IU (mg)

Value/range—50% daily value

Importance—Vitamin E serves a host of functions. It assists in red blood cell formation, acts as an antioxidant, and aids in the regulation of prostanoid synthesis. Prostanoids are compounds that are important in the reproductive process, and blood-platelet aggregation involved in control of bleeding. Vitamin E protects cell membranes against oxidation, prevents blood clots, retards oxidation of the other fat-soluble vitamins, helps cells respire, and treats or prevents vitamin deficiency. Of interest to athletes, Vitamin E has also been shown to lower the blood-lactate level, decrease the formation of certain waste products during exercise, reduce oxidative cellular damage, maintain muscle tissue, and possibly help testosterone production.

Performance Parameters—In studies intake of Vitamin E have been found to benefit athletes by improving energy production, reducing cellular damage, and stabilizing membranes.

Alternative Ingredient—None known. In this formulation this ingredient is critical because Vitamin E is not a water-soluble vitamin. This ingredient is more readily soluble in water, which is especially critical to the taste and clear appearance of the drink. It also remains in solution and has minimal settling properties when chilled or left in solution for long periods of time. It also maintains its potency when left in solution for long periods of time.

Limitations/Undesired Characteristics—None known for this dosage.

Vitamin B₁₂ (cyanocobalamin)

Quantity—6 μg

Value/range—100% daily value

Importance—Vitamin B₁₂ is only one part of the nutrition picture, but it is a very important part, playing an essential role in maintaining athletic performance. It is regarded as the primary energy vitamin. In fact, a common practice among athletes is to get Vitamin B₁₂ shots during the season. Vitamin B₁₂, also known as cobalamin, is really a group of cobalt-containing compounds that display Vitamin B₁₂ activity. Vitamin B₁₂ functions in the body in new cell growth nerve tissue development, folate metabolism, DNA synthesis and energy production. It is necessary for the synthesis of red blood cells and, therefore, for the prevention of anemia.

Performance Parameters—Studies conducted in the 1980s on non-athletes experiencing tiredness are credited with initiating the current practices of taking mega-doses of Vitamin B₁₂ and injecting B₁₂ that are so widespread among athletes. These studies use only Vitamin B₁₂ injections, though, the benefit of consuming mega-doses of B₁₂ have not yet been substantiated by research. Furthermore, various studies examining the strength and endurance effects of B₁₂ have not showed the vitamin to provide any immediate benefits. To date, Vitamin B₁₂'s primary function is metabolic. Researchers are currently focusing their attention on a coenzyme form of B₁₂ called cobamamide. Cobamamide is being touted as an anabolic form of B₁₂ that is comparable to anabolic steroids. According to athletes, however, cobamamide raises the perceived energy level and does increase appetite. Therefore, the use of coenzyme B₁₂ along with Vitamin B₁₂ is recommended for athletes.

Alternative Ingredient—None known. In this formulation this ingredient is critical because it is readily soluble in water which is critical to the taste and clear appearance of the drink. It also remains in solution and has minimal settling properties when chilled or left in solution for long periods of time. It also maintains its potency when left in solution for long periods of time.

Limitations/Undesired Characteristics—None known for this dosage.

Pantothenic acid or Vitamin B₅ (as D-calcium pantothenate)

Quantity—10 mg

Value/range—100% daily value

Importance—Pantothenic acid has many metabolic functions, primarily as a component of coenzyme A. Coenzyme A is important in the Krebs Cycle and in the metabolism of fatty acids. Pantothenic acid's metabolic functions are vital in the release of energy from carbohydrates and fatty acids. The vitamin is also involved in steroid and cholesterol synthesis.

Performance Parameters—According to studies, it has enhanced performance for endurance athletes when taken in amounts over the RDA for short periods of time. In studies patients who were given pantothenic acid supplements before and after surgery healed better than those who received no supplements.

Alternative Ingredient—None known. In this formulation this ingredient is critical because it is readily soluble in water which is critical to the taste and clear appearance of the drink. It also remains in solution and has minimal settling properties when chilled or left in solution for long periods of time. It also maintains its potency when left in solution for long periods of time.

Limitations/Undesired Characteristics—None known for this dosage.

Calcium (as calcium carbonate)

Quantity—50 mg

Value/range—5% daily value

Importance—The average adult body contains approximately 1,200 grams of Calcium, 99 percent of, which is located in the skeleton. Calcium is found in the skeleton primarily as calcium phosphate. Calcium also occurs in the body in ionic form and as calcium carbonate. In addition to its role as the primary nutrient needed for bone formation and maintenance, Calcium also plays essential roles in nerve conduction, nerve impulse transmission, heart rate, muscle contraction, cell-membrane permeability, and blood clotting. It also functions as a coenzyme. Recently, calcium level was found to be correlated to the control of blood pressure in some individuals. In bone formation and maintenance, a positive calcium balance, that is, more calcium absorbed than excreted is required for proper mineralization of bone. This positive balance must be maintained during the growth years and throughout adulthood. Until recently, most medical authorities believed that after the age of thirty, building more bone tissue became impossible.

Performance Parameters—Research has proven what many sports-fitness scientists already suspected, exercise and the proper dietary intake of calcium result in increased bone density in adults of all ages. For athletes these findings mean that adequate calcium level must be maintained year round, from childhood through the senior years.

Alternative Ingredient—None. Calcium carbonate contains one of the highest amounts of elemental calcium per milligram of all the calcium salts.

It is also the most readily absorbable of the calcium salts. A critical element in the maintenance of proper hydration and in the prevention of dehydration when used in the correct relationship to the other electrolytic elements.

Limitations/Undesired Characteristics—None known.

Magnesium—(from 30 mg of magnesium chloride)

Quantity—7.5 mg

Value/range—2% daily value

Importance—Most of the magnesium that is present in the body is located in the bones, muscles and soft tissues. Altogether, the average adult body contains about 24 grams of magnesium. Magnesium plays many metabolic and structural roles. It helps form bone and teeth, functions in muscle tissue development and the proper function of the nervous system, as well as activating enzymes. It assists calcium and potassium uptake, glycolysis, as well as many other metabolic processes. It aids the muscle to relax preventing muscle spasms, tremors and convulsions. It is a critical element in the treatment of chronic fatigue, which involves muscle aches and pains.

Performance Parameters—Athletes should note that several studies have shown that supplementing the diet with moderate amounts of magnesium improves several performance factors including endurance and strength. Researchers have also observed that athletes that increase their physical activity tend to deplete their magnesium stores, this especially true in endurance athletes.

Alternate Ingredient—None. In this formulation this ingredient is critical because of its solubility which is critical to the taste, color and clear appearance of the drink. It also remains in solution and has no settling properties when chilled or left in solution for long periods of time. It also maintains its potency when left in solution for long periods of time, which is critical to the overall effectiveness of the macronutrient modulation and interaction with other nutrients. A critical element in the maintenance of proper hydration and in the prevention of dehydration when used in the correct relationship to the other elements.

Why magnesium chloride instead of carbonate, oxide and glyconate or other salts?

1. Supplements generally combine pure or “elemental” magnesium with other chemicals or “salts”. The forms most commonly available are magnesium chloride, magnesium carbonate, magnesium oxide, magnesium malate, magnesium aspartate, and magnesium citrate.

A. One of the key issues in choosing a magnesium ingredient is the amount of elemental magnesium available in the ingredient not the magnesium salts.

B. Of the salts magnesium oxide contains the highest amount of the element calcium 60 percent, but it is not soluble; of the soluble salts the chloride provides a high amount of zinc.

C. In addition the studies used indicate that the two most absorbable form of magnesium are magnesium carbonate and magnesium chloride.

Limitations/Undesirable Characteristics—None known.

Zinc—(as zinc citrate)

Quantity—5 mg

Value/range—33% daily value

Importance—In athletic circles, zinc has acquired the reputation of being one of the primary healing nutrients and a major contributor to male fertility. Zinc plays many important metabolic roles in the body. It is part of various metallo-enzymes (mineral-containing enzymes) that function in growth, testosterone production, DNA synthesis, cell replication, fertility, reproduction, and prostate gland functioning. It occurs in ionic form in cells, assists in the synthesis of molecules, and serves as a component of enzymes. For athletes, maintaining proper zinc intake is vital, especially for the growth and repair of muscle tissue to meet the demands of training.

Performance Parameters—Very few studies have been conducted to examine the effects of zinc supplementation on performance, although one study did show that the effect is increased muscle endurance. Further research will indicated whether or not there are additional benefits for performance.

Alternative Ingredient—None. This is one of the forms of elemental zinc that are referred to as Chelated Zinc. It is a relatively inexpensive form of zinc and is well tolerated by the stomach and system. In this formula this ingredient is critical because of its solubility which is critical to the color and clear appearance of the drink. It is also one of the easiest elemental form to mask the taste. It also remains in solution and has no settling properties when chilled or left in solution for long periods of time which is critical for heavy element.

Why zinc citrate instead of oxide or monothionine?

1. Of all the zinc compounds zinc gluconate, citrate, and oxide, which are referred to as chelated zinc, are the best choices for most people, as they are relatively inexpensive and very well tolerated by the body.

2. Zinc sulfate is the most economical form but has a stronger after taste and has a history of being very irritating to the stomach.

3. Some practitioners use other forms of zinc such as picolinate and orate that they believe are more readily absorbed. However, this has not been proven in studies.

4. Zinc monothionine or “opti-zinc” is a very commonly used form but has a very strong taste and after taste. Monothionine also is extremely expensive and not a viable candidate at this time.

5. Needed for body to properly utilize Vitamin A.

Limitations/Undesirable Characteristics—After taste. No others known for this dosage.

Sodium—(from sodium chloride and sodium citrate)

Quantity—180 mg

Value/range—8% daily value

Importance—While potassium is the body's main intercellular cation, sodium is the body's main extracellular cation. Sodium helps regulate the body's volume of extra-cellular fluids, particularly the blood. It also helps regulate pressure of these fluids, aids the active transport of nutrients across cell membranes, and assists the uptake of some nutrients in the intestines. In addition, it functions in muscle contraction and nerve impulse transmission.

Performance Parameters—Studies support the adequate intake of sodium for the maintenance of overall health and athletic performance. A critical element in the maintenance of proper hydration and in the prevention of dehydration if used in the correct relationship to the other elements.

Alternative Ingredient—None. In this formulation these ingredients are essential because of their solubility which is critical to the taste, color and clear appearance of the drink. It also remains in solution and has no settling properties when chilled or left in solution for long periods of time. It also maintains its potency when left in solution for long periods of time, which is critical to the overall effectiveness of the macronutrient modulation and interaction with other nutrients. A critical element in the maintenance of proper hydration and in the prevention of dehydration when used in the correct relationship to the other elements.

Why sodium chloride and citrate instead of phosphate?

1. The main reason for the choice of chloride and citrate was the taste and color properties for our drink.

2. They are very conducive to drinks with a fruit flavor.

3. Sodium phosphate is one of the most active forms and is used in cola type drinks; it is very conducive to cola taste and color and not good for fruit flavor and color drinks.

Limitations/Undesirable Characteristics—None known.

Potassium—(from potassium phosphate)

Quantity—70 mg

Value/range—2% daily value

Importance—Potassium functions in the body primarily as an intercellular fluid cation. A cation is a positively charged ion. Intercellular fluid is any fluid that is found within a cell. As an intercellular cation potassium is essential to all living cells. It helps maintain fluid balance and functions in nerve transmission muscle contraction and glycogen formation.

Performance Parameters—Studies support the adequate intake of potassium for maintenance and overall health and athletic performance. A critical element in the maintenance of proper hydration and in the prevention of dehydration if used in the correct relationship to the other elements.

Alternative Ingredient—None. In this formulation these ingredients are essential because of their solubility which is critical to the color and clear appearance of the drink. It also remains in solution and has no settling properties when chilled or left in solution for long periods of time. It also maintains its potency when left in solution for long periods of time, which is critical to the overall effectiveness of the macronutrient modulation and interaction with other nutrients. A critical element in the maintenance of proper hydration and in the prevention of dehydration when used in the correct relationship to the other elements.

Limitations/Undesirable Characteristics—None known.

Inactive Ingredients:

Simple carbohydrates (dextrose)

Quantity—20 g

Value/range—7% daily value

Importance—Simple carbohydrates are the major source of energy for physical activities.

Performance Parameters—Carbohydrates are the best energy source because they most effectively replenish the glycogen stores in the muscles and liver. In addition, they elevate the blood sugar to a level sufficient for long sessions of intensive training. Research, has shown that athletes must make sure that they consume adequate amounts of both carbohydrates and protein. If the athlete's energy stores become drastically depleted or they experience lactic-acid build up, they will suffer temporary muscle fatigue. If the glycogen stores are not replenished before the next work out or game, their body will begin breaking down muscle tissue for the protein it needs to generate energy.

Alternative Ingredient—None. In this formulation this ingredient is used as a sweetener as well as the generating source of energy. This form is used in electrolyte or rehydration formulations because of its effectiveness. This ingredient is readily soluble in water, which is critical to the clear appearance of the drink. It also remains in solution and will not settle when chilled or left in solution for long periods of time.

Limitations/Undesired Characteristics—Can have negative impact on people with diabetes. Excessive levels cause the blood sugar level to fall because of excess insulin production.

L-Glutamine

Quantity—25 mg

Value/range—None

Importance—L-glutamine is formed from glutamic acid by the addition of ammonia catalyzed by vitamin B₆. L-glutamine is a neurotransmitter in the brain, where it can be converted back to glutamic acid. It is essential for the proper functioning of the brain. It is an energy source in the brain and a mediator of glutamic acid and GABA activity. Lglutamine is also vital to immune system functioning. New studies show that L-glutamine is required for cellular replication in the immune system. However, the majority of L-glutamine is made in the muscles.

Performance Parameters—Use of supplemental free-form L-glutamine by athletes is known to produce a strong anticatabolic effect, which neutralizes the cortisol that accompanies strenuous exercise. Cortisol is a steroid hormone and highly catabolic. L-glutamine's anticatabolic action allows more efficient anabolism. L-glutamine is also active in recovery and healing. Is active in alleviating fatigue, improving brain function and as a mood elevator.

Alternative Ingredient—None available.

Limitations/Undesirable-characteristics—None known.

Glycine

Quantity—35 mg

Value/range—None

Importance—Glycine is an important precursor of many substances, including protein, DNA, phospholipids, collagen, and creatine. It is also a precursor in the release of energy. Glycine is used by the liver in the elimination of phenols, which are toxic, and in the formation of bile salts. It is necessary for the proper functioning of the central nervous system and is an inhibitory neurotransmitter. Too much supplemental Glycine can displace glucose in the metabolic energy chain and cause fatigue, but just enough can help produce more energy.

Performance Parameters—Some studies have also noted that glycine ingestion causes an increase in strength, possibly due in part to its elevation of the growth hormone levels. Supplemental glycine has additionally been shown to increase the creatine level the major source of muscle. Glycine should be part of all full-spectrum amino acid supplements.

Alternative Ingredient—None available.

Limitations/Undesirable Characteristics—None known for this dosage.

L-Valine

Quantity—25 mg

Value/range—None

Importance—L-Valine is an essential amino acid and a member of the branched-chain amino acids (BCAAs). Like other BCAAs, it is an integral part of muscle tissue and may be used for energy by exercising muscles. It is involved in tissue repair, nitrogen balance, and muscle metabolism. BCAAs regulate how the body uses protein and play a unique role in protein metabolism in muscles. They are oxidized in peripheral muscles. They are the principal source of calories for muscle tissue. Intense physical exercise produces a rapid excretion of nitrogen, which causes a decrease in muscle protein synthesis. L-valine supplementation limits this decrease.

Performance Parameters—Studies have shown that L-valine balances insulin secretions and directly affects muscle and body weight changes and promotes lean muscle distribution. L-valine has been shown to reduce appetite while preserving basic protein storage in the body. It also has been demonstrated to be available to muscles in one hour.

Alternative Ingredient—None available.

Limitations/Undesirable Characteristics—None known.

L-Isoleucine

Quantity—25 mg

Value/range—None

Importance—L-Isoleucine is an essential amino acid found in proteins that is, one of the branched-chain amino acids (BCAAs). Like the other BCAAs, it is an integral part of muscle tissue and may be used for energy by exercising muscles. L-isoleucine is found in proteins and is needed for the formation of hemoglobin. It is involved in the regulation of blood sugar and is metabolized for energy in muscle tissue during exercise.

Supplemental intake of L-isoleucine, along with the other BCAAs, has been shown to help spare muscle tissue, maintain nitrogen balance, and promote muscle growth and healing. BCCAs regulate how the body uses protein and play a unique role in protein metabolism in muscles. They are oxidized in peripheral muscles. They are the principal source of calories for muscle tissue. Intense physical exercise produces a rapid excretion of nitrogen, which causes a decrease in muscle protein synthesis. L-isoleucine supplementation limits this decrease.

Performance Parameters—Studies have shown that L-isoleucine balances insulin secretions and directly affects muscle and body weight changes and promotes lean muscle distribution. L-isoleucine has been shown to reduce appetite while preserving basic protein storage in the body. It also has been shown to be available to muscles in one hour. Alternative Ingredient—None available.

Limitations/Undesirable Characteristics—None known.

L-Leucine

Quantity—40 mg

Value/range—None

Importance—L-leucine is an essential amino acid found in proteins that is, like the other branched-chain amino acids (BCAAs), important in energy production during exercise. For many years, the three BCAAs were assumed to contribute equally to energy. Recent studies, however, have shown that both exercising and resting muscle tissue use far more Lleucine for energy than either of the other two BCAAs. According to estimates, up to 90 percent of dietary L-leucine may be used for energy in existing muscles. This makes L-leucine a very limiting amino acid if supplemental amounts are not taken to compensate for the loss. Supplemental intake of L-leucine, along with the other BCAAs, has been shown to help spare muscle tissue, maintain nitrogen balance, and promote muscle growth and healing. They regulate how the body uses protein and play a unique role in protein metabolism in muscles. They are oxidized in peripheral muscles. They are the principal source of calories for muscle tissue. Intense physical exercise produces a rapid excretion of nitrogen, which causes a decrease in muscle protein synthesis. Leucine limits this decrease.

Performance Parameters—Studies have shown that it balances insulin secretions and directly affects muscle and body weight changes and promotes lean muscle distribution. L-leucine has been shown to reduce appetite while preserving basic protein storage in the body. It also has been shown to be available to muscles in one hour.

Alternative Ingredient—None available.

Limitations/Undesirable Characteristics—None known.

Glucosamine HCL (from glucosamine hydrochloride)

Quantity—50 mg

Value/rating—None

Importance—Glucosamine, an amino sugar, as a supplement is widely heralded as an effective treatment for arthritis. It has properties that also benefit all types of connective tissue. These different types of connective tissue make up the tendons, ligaments, intravertebral discs, and pads between the joints, cell membranes, and cartilage. Connective tissue has two components. The chief component is collagen, which is the most common protein in the body, making up one-third of the body's total protein volume. The other component is proteoglycan (PG), which forms the framework for collagenous tissue. PGs are large molecules comprised mainly of glycosaminoglycans (GAGs), which are long chains of modified sugars. Over 30 years of research has gone into understanding how glucosamine acts as a precursor in GAG synthesis.

Performance Parameters—Research has shown that in many cases it has had a positive effect on athletes in both accelerating the healing process and providing relief from joint and cartilage injuries. Scientists have long known that ingesting purified glucosamine from connective tissue allows the body to bypass the step of converting glucose to glucosamine. Supplemental glucosamine clearly aids in the synthesis of connective tissue. All athletes need a supplement that can do this, as the repair and growth of connective tissue is never ending.

Alternative Ingredient—None known. This ingredient is readily soluble in water, which is critical to the clear appearance of the drink. It also remains in solution and will not settle when chilled or left in solution for long periods of time.

Limitations/Undesirable Characteristics—None known.

Rutin

Quantity—25 mg

Value/rating—None

Importance—A water-soluble bioflavonoid and naturally occurring plant compound associated with Vitamin C. Bioflavonoids actually improve the Vitamin C absorption. They also have an anti-inflammatory effect. They exhibit antioxidant activity and help reduce the destruction of Vitamin C.

Performance Parameters—The bioflavonoids have been proven to strengthen the capillary walls and thereby prevent capillary damage and leakage. The ergogenic effects of the bioflavonoids have not yet been tested, but this group of plant compounds has been noted to improve recovery and to provide nutritional support for athletes healing from injuries.

Alternative Ingredient—None known. This ingredient is readily soluble in water, which is critical to the clear appearance of the drink. It also is used as a color enhancer for this formula delivering the desired color. It also remains in solution and will not settle when chilled or left in solution for long periods of time.

Limitations/Undesirable Characteristics—None Known.

Other Ingredients:

Citric Acid

Quantity—(as needed)

Value/rating—None

Importance—A water-soluble natural organic acidulant found widely in citrus plants.

Performance Parameters—Citric Acid is used in this formula to retard the oxidation of fats and oils and to help maintain the clear transparent quality of this drink product. In this formulation it is also used to modify the flavor and to aid in the preservation by lowering the pH level and supporting the orange flavor.

Alternative Ingredient—None. This ingredient is readily soluble in water, which is critical to the clear appearance of the drink. It also remains in solution and will not settle when chilled or left in solution for long periods of time.

Limitations/Undesirable Characteristics—None.

Natural Flavors (lemon)

Quantity—(as needed)

Value/rating—None.

Importance—This special combination of natural occurring fruit flavors is formulated, mixed and manufactured specifically for this product.

Performance Parameters—This is one of the most critical components in this product formulation as it functions as a taste-masking ingredient. It also provides a pleasant natural fruity aroma, which corresponds to the designated flavor. In this formulation this ingredient is essential because it solubility which is critical to the color and clear appearance of the drink. It also remains in solution and has no settling properties when chilled or left in solution for long periods of time. Leaves no residue on containers when mixed.

Alternative Ingredient—None. This ingredient is readily soluble in water, which is critical to the clear appearance of the drink. It also remains in solution and will not settle when chilled or left in solution for long periods of time.

Limitations/Undesirable Characteristics—None.

Acesulfame Potassium

Quantity—(as needed)

Value/rating—None.

Importance—Also known as Acesulfame K, it looks like sugar, but is derived from acetoacetic acid and has no caloric value.

Performance Parameters—A sweetener similar to Aspartame and Saccharin in appearance and like both of them has no caloric value. It differs from Aspartame in that it has no relationship to the amino acid phenylalanine, which can cause complications with users that are sugar sensitive or diabetic. It differs from Saccharin a petroleum-based sweetener that is absorbed but not modified by the body, and is excreted unchanged by the body.

Alternative Ingredient—None. This ingredient is readily soluble in water, which is critical to the clear appearance of the drink. It also remains in solution and will not settle when chilled or left in solution for long periods of time.

Limitations/Undesirable Characteristics—None.

Turmeric

Quantity—(as needed)

Value/rating—None.

Importance—Used as a colorant.

Performance Parameters—Dissolves readily and clearly in water and remains in solution for extended periods of time. Will not settle out of solution when chilled. Leaves no color residue or stain on containers.

Alternative Ingredient—None known. This ingredient is readily soluble in water, which is critical to the clear appearance of the drink. It also remains in solution and will not settle when chilled or left in solution for long periods of time.

Limitations/Undesirable Characteristics—None known.

Results

Numerous amateur athletes including the inventor have used the inventive formula. The solution is pleasant tasting and consumption during exercise clearly provided hydration and energy with no digestive distress. The product was evaluated by two professional athletes training during offseason under the direction of a personal trainer. The athletes reported that consumption of the inventive beverage during training episodes allowed them to train significantly longer than other athletic drinks they had been using. Significantly, they reported that loss of muscle control following very strenuous training episodes was greatly reduced by consumption of the inventive beverage.

The inventive beverage was also used as a training aid during the preseason training of a Midwestern University football team. The trainers were concerned with dehydration and weight loss caused by training. The problem was so great that intravenous administration of fluids was often required. Use of the inventive beverage significantly reduced instances of intravenous fluid administration and shortened the time that athletes needed to rest after training before they could attend meetings. The present invention provides a unique formula for energy and hydration during strenuous activity. The combination of straight chain and branched chain (with leucine dominant) amino acids supplement glucose for energy production in muscle tissue. It is believed that the hypotonic combination of salts and glucose provide for rapid and painless absorption of water, salts and carbohydrate. The vitamins facilitate metabolism and provide significant antioxidants (both water and lipid soluble). The antioxidant effect is backed up by rutin, an antioxidant bioflavonoid. Glucosamine is provided for the long-term condition of connective tissue and joint lubricity.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. An aqueous beverage for maximizing endurance and hydration during physical exercise in the form of a substantially optically clear solution wherein a sixteen ounce serving comprises:
glucose as a carbohydrate source providing between about 3 and about 10 calories per ounce of said solution;
between about 25 mg and about 100 mg of calcium from a calcium salt;
sodium and potassium from sodium and potassium salts respectively, in a weight ratio between about 2:1 and about 3:1, wherein weight of the sodium is between about 2 times and about 4 times weight of calcium in the solution;
magnesium and zinc, from magnesium and zinc salts respectively, wherein a weight ratio of magnesium to zinc is between about 1:1 and about 2:1, and wherein a weight ratio calcium to magnesium is between about 5:1 to about 15:1;
quantities of vitamin B₁₂ and pantothenic acid, wherein each quantity is between about 10% and about 300% of recommended daily value;
quantities of vitamin C and vitamin E, wherein each quantity is between about 10% and 300% of recommended daily value;
rutin weighing between about 0.5 and 1.5 times vitamin C in the solution;
a mixture of branched chain and straight chain amino acids wherein a weight ratio between glucose in the solution and the mixture of amino acids in the solution is between 100:1 and 200:1; and
glucosamine wherein a molar ratio between glucose in the solution and glucosamine in the solution is between about 300:1 and about 800:1.

2. The aqueous beverage for maximizing endurance and hydration during physical exercise according to claim 1, wherein the mixture of branched chain and straight chain amino acids comprises valine, isoleucine and leucine as branched chain amino acids and comprises glutamine and glycine as straight chain amino acids.

3. The aqueous beverage for maximizing endurance and hydration during physical exercise according to claim 2, wherein a molar ratio of straight chain amino acids to branched chain amino acids is about 1:1.

4. The aqueous beverage for maximizing endurance and hydration during physical exercise according to claim 2, wherein a molar ratio of glycine to glutamine to valine to isoleucine to leucine is about 5:2:2:2:3.

5. The aqueous beverage for maximizing endurance and hydration during physical exercise according to claim 1, wherein the glucose provides about 6 calories per ounce of said solution.

6. The aqueous beverage for maximizing endurance and hydration during physical exercise according to claim 5, wherein the molar ratio between glucose in the solution and glutamine in the solution is about 5:1.

7. The aqueous beverage for maximizing endurance and hydration during physical exercise according to claim 5, wherein the molar ratio between glucose in the solution and glucosamine in the solution is about 580:1.

8. The aqueous beverage for maximizing endurance and hydration during physical exercise according to claim 1, wherein the rutin weighs about 0.8 times vitamin C.

9. The aqueous beverage for maximizing endurance and hydration during physical exercise according to claim 1, further comprising a quantity of vitamin A between 1% and 150% of the recommended daily value.

10. The aqueous beverage for maximizing endurance and hydration during physical exercise according to claim 1, wherein about one third of the recommended daily value of vitamin C is provided.

11. The aqueous beverage for maximizing endurance and hydration during physical exercise according to claim 1, wherein about one half of the recommended daily value of vitamin E is provided.

12. The aqueous beverage for maximizing endurance and hydration during physical exercise according to claim 1, wherein about all of the recommended daily value of vitamin B₁₂ is provided.

13. The aqueous beverage for maximizing endurance and hydration during physical exercise according to claim 1, wherein about all of the recommended daily value of pantothenic acid is provided.

14. The aqueous beverage for maximizing endurance and hydration during physical exercise according to claim 1, wherein about 50 mg of calcium is provided.

15. The aqueous beverage for maximizing endurance and hydration during physical exercise according to claim 1, wherein about 180 mg of sodium is provided.

16. The aqueous beverage for maximizing endurance and hydration during physical exercise according to claim 15, wherein the weight ratio between sodium and potassium is about 2.5:1.

17. The aqueous beverage for maximizing endurance and hydration during physical exercise according to claim 1, wherein the weight ratio of magnesium to zinc is about 1.5:1.

18. The aqueous beverage for maximizing endurance and hydration during physical exercise according to claim 1, wherein a weight ratio between calcium to magnesium to zinc to sodium to potassium is about 10:1.5:1:36:14.

19. An aqueous beverage for maximizing endurance and hydration during physical exercise in the form of a substantially optically clear solution wherein a sixteen ounce serving comprises:
glucose as a carbohydrate source providing between about 3 and about 10 calories per ounce of said solution;
between about 25 mg and about 100 mg of calcium from a calcium salt;
sodium and potassium from sodium and potassium salts respectively, in a weight ratio between about 2:1 and about 3:1;
magnesium from magnesium salts, wherein a weight ratio calcium to magnesium is between about 5:1 to about 15:1;
quantities of vitamin C and vitamin E, wherein each quantity is between about 10% and 300% of recommended daily value;
rutin weighing between about 0.5 and 1.5 times vitamin C in the solution; and
a mixture of branched chain and straight chain amino acids.

20. The aqueous beverage for maximizing endurance and hydration during physical exercise according to claim 19, wherein, weight of the sodium is between about 2 times and about 4 times weight of calcium in the solution.

21. The aqueous beverage for maximizing endurance and hydration during physical exercise according to claim 19, further comprising zinc from zinc salts.

22. The aqueous beverage for maximizing endurance and hydration during physical exercise according to claim 21, wherein a weight ratio of magnesium to zinc is between about 1:1 and about 2:1.

23. The aqueous beverage for maximizing endurance and hydration during physical exercise according to claim 19, further comprising a quantity of vitamin B₁₂.

24. The aqueous beverage for maximizing endurance and hydration during physical exercise according to claim 23, wherein the quantity of vitamin B₁₂ is between about 10% and about 300% of recommended daily value.

25. The aqueous beverage for maximizing endurance and hydration during physical exercise according to claim 19, further comprising a quantity of pantothenic acid.

26. The aqueous beverage for maximizing endurance and hydration during physical exercise according to claim 25, wherein the quantity of pantothenic acid is between about 10% and about 300% of recommended daily value.

27. The aqueous beverage for maximizing endurance and hydration during physical exercise according to claim 19, wherein a weight of branched chain amino acids approximately equals a weight of straight amino acids.

28. The aqueous beverage for maximizing endurance and hydration during physical exercise according to claim 19, wherein the straight chain amino acids comprise glycine and glutamine.

29. The aqueous beverage for maximizing endurance and hydration during physical exercise according to claim 19, wherein the branched chain amino acids comprise valine, leucine and isoleucine.

30. The aqueous beverage for maximizing endurance and hydration during physical exercise according to claim 19, further comprising glucosamine.

31. The aqueous beverage for maximizing endurance and hydration during physical exercise according to claim 19, further comprising a quantity of vitamin A.

32. The aqueous beverage for maximizing endurance and hydration during physical exercise according to claim 19, wherein the quantity of vitamin A is between about 1% and about 150% of recommended daily value.

33. An aqueous beverage for maximizing endurance and hydration during physical exercise in the form of a substantially optically clear solution wherein a sixteen ounce serving comprises:
glucose as a carbohydrate source providing about 6 calories per ounce of said solution;
about 50 mg of calcium from a calcium salt;
about 180 mg of sodium from sodium salts;
about 70 mg of potassium from potassium salts;
magnesium and zinc, from magnesium and zinc salts respectively providing about 5 mg of zinc, wherein a weight ratio of magnesium to zinc is about 1.5:1;
about 100% of the recommended daily value of vitamin B₁₂ and pantothenic acid;
about 20 mg of vitamin C;
about 50% of recommended daily value of vitamin E;
about 25 mg of rutin;
a mixture of branched chain and straight chain amino acids comprising about 35 mg of glycine, about 25 mg of glutamine, about 25 mg of valine, about 25 mg of isoleucine and about 40 mg of leucine; and
about 50 mg of glucosamine hydrochloride.

34. A method of ensuring energy levels and hydration during exercise comprising the step of consuming one or more servings of the aqueous beverage according to claim 1.

35. A method of ensuring energy levels and hydration during exercise comprising the step of consuming one or more servings of the aqueous beverage according to claim 19.

36. A method of ensuring energy levels and hydration during exercise comprising the step of consuming one or more servings of the aqueous beverage according to claim 33.
